(19) United States
(12) Patent Application Publication
(10) Pub. No.: US 2003/0204523 A1
(43) Pub. Date: Oct. 30, 2003

(54) Database management system

(76) Inventor: Nigel Leck, Newport (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/153,187

(22) Filed: May 20, 2002

(30) Foreign Application Priority Data
May 18, 2001 (AU) PR5110
May 24, 2001 (AU) 2001100004

(51) Int. Cl. G06F 7/00

(52) U.S. Cl. 707/102

(57) ABSTRACT

A database for use by a plurality of user groups, the database including: designation means for designating data into one of the following sets, a general set for data of potential general applicability to all user groups, the data within the general set being customizable only by one or more system administrators, and a specific set for each individual user group for data of potential applicability to only that user group, the data within the specific set being customizable only by the user group, whereby the information as presented to any selected user group is the result of aggregation of the data from the general set and the specific set for the selected group. Preferably the sets into which the designation means is capable of designating data further includes one or more intermediate sets for data of potential applicability to one or more sub-sets of user groups respectively.

### RELATED APPLICATIONS

This application claims the benefit of the Australian applications PR5110 filed May 18, 2001 and 2001100004 filed May 24, 2001.

### BACKGROUND OF THE INVENTION

1. Field of the Invention

The present invention relates to information technology and in particular to a database management system for use by a plurality of disparate user groups. The invention has been developed primarily for delivery to various customers via an on-line connection such as through the Internet, however it will be appreciated that the invention is not limited to this particular field of use. A preferred embodiment of the invention is referred to as “Super-Tracker” by the applicant.

2. Description of the Related Art

Various businesses and in particular small to medium sized entities (SME's) are faced with an increasing need to handle many different kinds of business information. Business owners want to simplify their paper work (quotes, job sheets and invoices); locate information about customers, materials and personnel quickly; have inexpensive but professional looking forms that suit their business; and do simple profit and loss calculations on jobs. Office staff needs to know where delivery and installation staff were, what jobs had been finished and any problems to follow up. Staff out on site need to know what the job entailed, where they were supposed to be going—and those incidental but vital bits of information, like—where they could get parking and to beware of the dog! They also need to let the office know about any changes so the new details can be recorded. Data security and access away from offices is becoming a critical factor in business success. SMEs need affordable information management systems they can access anywhere, anytime—and be certain their data is secure.

Lack of fit with business requirements, problems with customization, cost and maintenance (installation, upgrades, customization, backups, security) are critical limiting factors in SME take up of management database programs and applications, and the performance benefits they offer.

Various user groups have experienced problems with developing and customizing databases to fit specific needs. When a database is written every item must have a unique name identifier so it can be located. In order to avoid naming conflicts between tables created by the original programmers and those initiated by the user, users generally cannot be allowed to change the underlying schema of the database to reflect their own particular requirements. To be able to upgrade, programmers would have to trace changes and make adjustments manually to each database. This can be a huge and very expensive task, even with a relatively small number of data bases.

The present inventor has identified two sets of interlocking issues relating to available database programs and applications, particular, but not exclusively, in relation to SME'S:

| USERS | DEVELOPERS |
|---|---|
| Increased ‘need to know’ - | High performing applications are |
| tax, litigation, warranties | very expensive |
| etc | |
| Generic programs don't suit. | How to increase levels of |
| Each industry and business has | customization and make process |
| different requirements | simple for users? |
| Needs change over time with | How to sustain customized |
| growth, as markets, | changes over time, and |
| expectations and practices | incorporate additional changes? |
| alter | |
| Cost of software - needs to be | How to reduce development and |
| affordable | administration costs? |
| Increased numbers of users | How to deliver application and |
| (scalability) | provide support, cost |
| | effectively, to large numbers of |
| | users? |

In summary the some problems relating to prior art databases are:

i. Lack of fit between business needs and database formats resulting from limitations to customization;

ii. Need to separate user initiated changes from core schema; and

iii. High development and maintenance costs of customized databases.

Any discussion of the prior art throughout the specification should in no way be considered as an admission that such prior art is widely known or forms part of common general knowledge in the field.

### SUMMARY OF THE INVENTION

It is an object of the present invention to overcome or ameliorate at least one of the disadvantages of the prior art, or to provide a useful alternative.

According to the invention there is provided a database for use by a plurality of user groups, said database including designation means for designating data into one of the following sets: a general set for data of potential general applicability to all user groups, the data within said general set being customizable only by one or more system administrators and a specific set for each individual user group for data of potential applicability to only that user group, the data within said specific set being customizable only by said user group whereby the information as presented to any selected user group is the result of aggregation of the data from said general set and the specific set for said selected group.

Preferably the sets into which said designation means is capable of designating data further includes one or more intermediate sets for data of potential applicability to one or more sub-sets of user groups respectively. For example, the preferred embodiment includes “industry” sets into which data of potential relevant to a particular industry may be designated. Preferably the data within said intermediate sets is customizable only by one or more system administrators.

In the preferred embodiment data stored in each of said sets is stored in a uniform format which consists of three tables, known as the row table, the field table and the global key table.

### BRIEF DESCRIPTION OF THE DRAWINGS

A preferred embodiment will now be described, with reference to the accompanying drawings in which:

FIG. 1 is a diagram illustrating a conceptualization of the invention;

FIG. 2 is another diagram illustrating a conceptualization of the invention, wherein different views as seen by different users are evident;

FIG. 3 is a diagram illustrating a user's view of a database as provided by the invention;

FIG. 4 is a conceptual diagram similar to FIG. 2;

FIG. 5 is a schematic diagram illustrating three sets (or layers as they are also referred to in this document) and an index database (also referred to as aspc_master).

FIG. 6 illustrates Virtual DBfield tables of diagram 10.

FIG. 7 illustrates three screens for database layers of diagrams 19, 20 and 21.

FIG. 8 is a block diagram of the system implemented as a bureau model.

### DETAILED DESCRIPTION OF THE PREFERRED EMBODIMENT

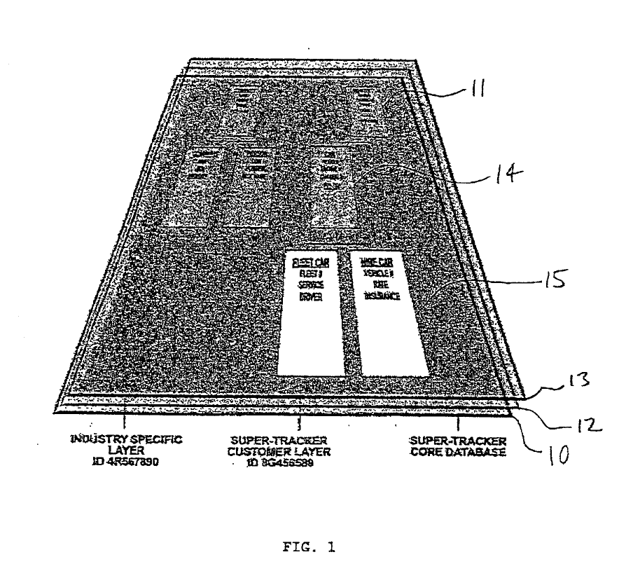

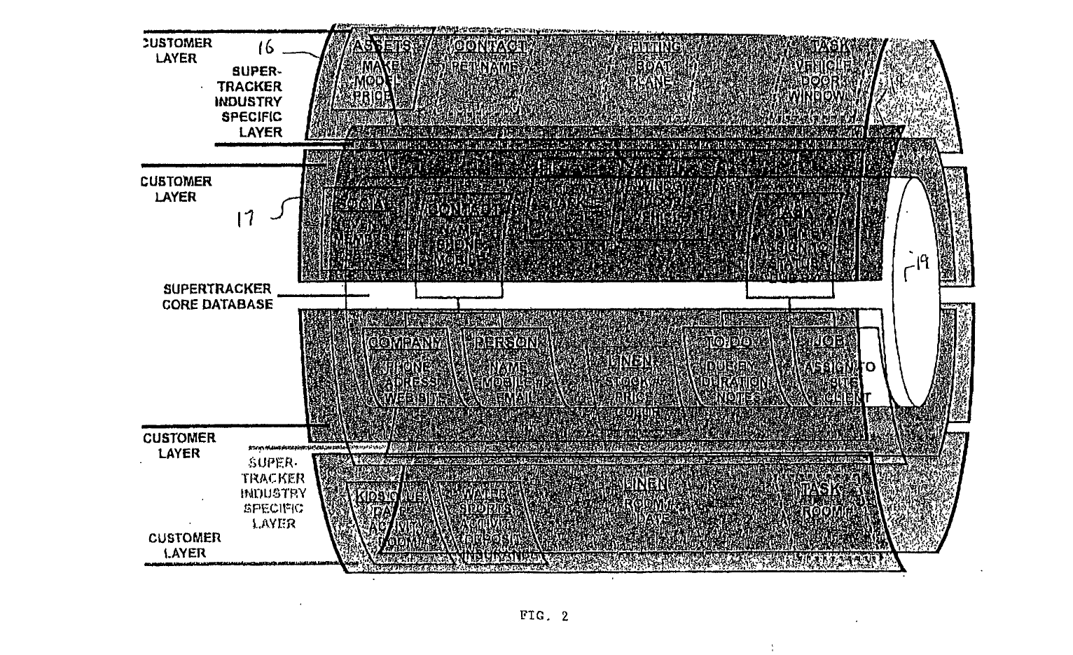

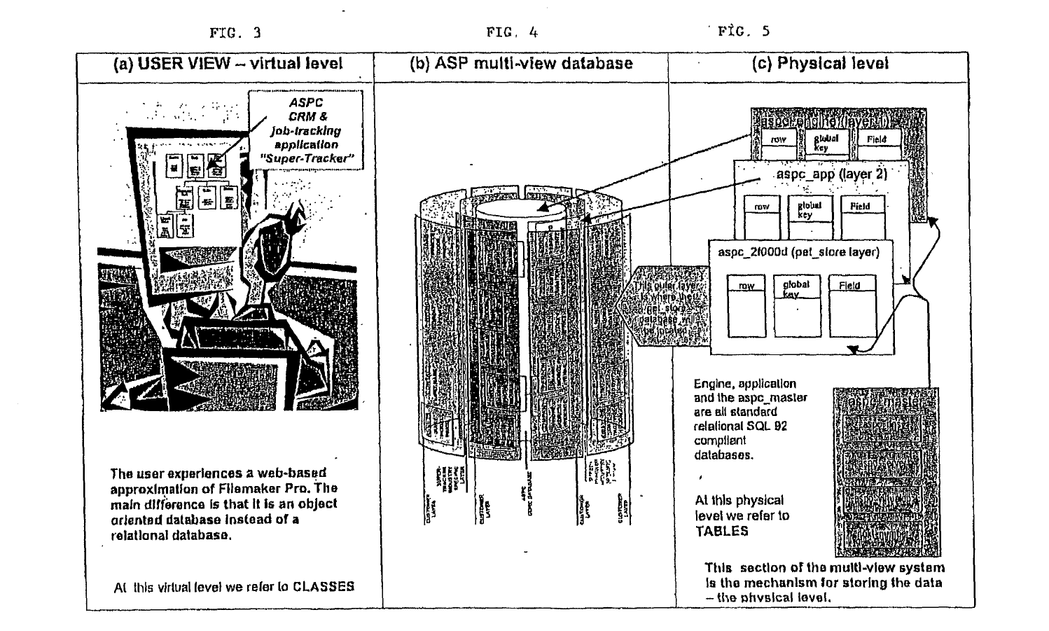

For the sake of conceptualizing the invention, the sets may be conceived of as layers, for example as layers of transparent glass upon which information is printed, such as those shown in FIG. 1. The bottom layer of glass 10 contains basic information 11 which has the potential to be viewed by all user groups. Subsequent layers of glass 12 and 13 are added with each new layer having information 14 and 15 of ever greater specificity to the user viewing the database. In other words the information on each additional layer has greater potential applicability to the user compared to that on lower layers. FIG. 2 shows the various views available to different user groups. For example, one user group may view the database through specific set (or upper-most layer) 16. Whereas another user group may view the database through specific set (or upper-most layer) 17. Both users may see information from the lower layers (that is, intermediate set 18 and general set 19), however each view is conditioned by the changes made in the relevant specific sets 16 or 17.

It is possible for each new layer to change the information ultimately visible to the user. Each new layer may add additional information, delete information from lower layers or change other aspects such as the manner in which the information is presented on the user's screen. This functionality, whereby each layer has the potential to present information to the user and to alter information from lower layers, is referred to in this document as “aggregation”.

The preferred embodiment of the present invention delivers multiple, highly customizable databases, based on a single database application that could be administered and upgraded centrally. The preferred embodiment allows high levels of customization to be maintained when the core database is enhanced. The preferred embodiment is a generic product, for a large market, with low development and maintenance costs.

The preferred embodiment of the invention provides solutions to the three main problems identified above:

i. It is highly customizable, in the sense that it is relatively simple for users to make changes reflecting their business requirements;

ii. Customization is performed in each user groups specific set (or upper most layer in the conceptualization). Users cannot access layers below their own, to make changes, only the database manager (also known as the system administrator) can make changes to these lower levels. In this way changes initiated by the user are kept separate from changes initiated by the database manager. The core schema is the same for all users and any programmed changes made to it are available to all users;

iii. With only one database to develop and administer, costs are a fraction of producing, maintaining and upgrading multiple database schema.

The multi-layered database of the preferred embodiment of the present invention is preferably distributed and accessed over wide or local area networks (internet or intranet). It allows multiple users to view and access only their own data within a virtual object oriented database. A series of relational databases are layered one over the other, in ever increasingly customized (specific to the requirements of particular groups of users) sets. These connect to a master database labeled aspc_master in FIG. 5 which acts as an index, holding the location details of all layers and entities within them.

Customization of the look, feel, layout etc and extension of the database for the user/group takes place in the layers and remains specific to that user/group. To achieve this, the core database (engine) is extended (rather than copied). Changes made to the core database are automatically ‘inherited’ up into the layers by making changes to customer layers.

A variety of applications are available to utilize the core database e.g. Contact management, job tracking and scheduling, accounting etc.

Importantly, as new features are customized for clients, they can be programmed, as appropriate, either into the core (general set)—or the industry layer (intermediate set), and passed on to users, where relevant, as an added feature.

The user experiences the system as a single virtual (object oriented) database. The interface is a combination of all layers from the engine, through the aspc layer, then up through a potentially very large number of layers (though in practice, 3 to five layers is the most common) such as an industry layer, an industry segment layer, then an individual company or user layer. A client views their data, as a unique slice through these layers.

The user's data is always stored in databases in the physical level. Conceptually, each database may be made up of three generic tables (row, field and global key). For performance reasons these generic three tables may be broken down based on the root class of each. In each layer only the information that is different to the layers below is stored. When the system is enhanced you get the changes—plus you get to keep your changes. This allows a single system administrator to administer a large number of databases, effectively as one. The system preferably has qualifiers and safeguards built in.

For the sake of illustration, a worked example will now be described based upon the following scenario:

The system administrator has a new client who runs a small business, Pet Store, a small chain of pet shops with associated grooming, boarding and exercise services. The client currently manages business information with a variety of customized spreadsheets and relational databases developed from off-the shelf products. The business was originally limited to the sale of pets and associated products but has grown quickly since the recent extension into providing pet services. With growth and increased complexity has come the need for a comprehensive data management system. The owner is looking to franchise the business, and therefore wants a system which will serve future needs of a central office and scattered, relatively independently run units. She has investigated the possibility of customizing her existing databases to incorporate the additional information required for these additional facets of the business. She wants a single system that will fit her business needs precisely—and allow her to make changes when new extensions and directions for the business develop. She has decided that an internet based database application according to the preferred embodiment of the present invention will give the flexibility and performance she requires for her business at a price she can afford.

### Client Requirements

The client wants to use the database to record standard information such as client details (e.g. name, address, phone, mobile). They would also need various screens for data entry, searching, reports and so on. Many of these classes, and fields within, them would have been created already and exist in the engine and application layer. If there were a relevant industry layer, for example, for veterinary services, there may be existing classes such as animal type, medications, inoculation details and so on.

For the sake of simplicity the present example will assume that there is no such industry layer (i.e. intermediate set), so any classes relating to pets (animal type, breed, name, food requirements, likes and dislikes etc) will need to be created in the client specific layer (i.e. the specific set). However, there is no need to create a class for the owner details, as this will be inherited from the application layer (where it is called contact).

The new client also wants to be able to perform the standard transactions such as recording sales (products), making bookings (boarding arrangements), scheduling jobs (e.g., grooming, dog walking), and writing invoices.

### What Needs to be Done

As with any new client, a new ‘virtual database’ (a compilation of all layers from the engine, up through increasingly customized layers) will be created. This must be done, no matter how closely the requirements of the new client fit with an existing database (e.g. an industry layer). If, this was not done, and, for example, the new client were allowed to enter data in one of the lower layers (e.g.. aspc_app), all users would see whatever data was entered, and would get whatever new classes and fields were added, in their database (layer). Creating a new virtual database for each new client (account holder) is the mechanism for keeping these changes separate, and for ensuring that account holders only see and have access to their own data.

The steps for ASPC programmers, in providing a customizable database to the requirements specified by Pet Store, which is accessible only by this client (and any users she authorizes), would be to:

1. Create a new database for the client (Pet Store)

2. Create additional class in that layer, in the example, a new class ‘pet’ is created

3. Add three fields to class ‘pet’ id, name, owner & type.

4. Extend the class ‘person’ (inherited from contact) with a new field called ‘favorite animal’.

The example also demonstrates some transactions executed in the pet_store layer:

5. A new record was created for class person, Tina Leck.

6. Two records were then created for class pet (Fido and Megs)

7. A pre-existing record for person was modified by over-loading to change their mobile phone, favorite animal and comments.

19. Creating a New Database: Pet Store

As with any new customer/account holder, a new Virtual Database must be created. This is where all the client's records will be stored.

aspc_master functions as an index, holding all information about all other databases, their components and what they extend. It is not a layer. It has 4 tables.

DIAGRAM 1: aspc_master
List of relations

| Name | Type | Owner |
|---|---|---|
| aspc_dns | table | postgres |
| aspc_server | table | postgres |
| aspc_virtualdb | table | postgres |
| next_number | table | postgres |
| (4 rows) | | |

The master database table, aspc_server, (DIAGRAM 2) is used for creating new databases.

Information is stored here about where to locate the new database (what server), and what type it is (here postgres—could be oracle or any other type). Each new database is given unique number made up of the system's number (mask ) and the next sequential number. This ensures a globally unique number.

DIAGRAM 2 aspc_master database unique id

| aspc_master=# | select * from aspc_server; | | |
|---|---|---|---|
| mask | signature | newdburl | newdbconnecttype |
| 2097152000 | ASPC | devserver | POSTGRESQL |
| (1 row) | | | |

The process to do this is

1) Generate a new globally unique layer ID which is a combination of the server mask (found in aspc_server) and the next sequential number.

2) Place a record into aspc_dns which contains the human readable name for the virtual database and the layer ID.

3) Create a new physical database for the layer, using an auto-generated name. This is a combination of the layer ID and signature from the table (aspc_server) and database server location (from aspc_server) and database server type (from aspc_server)

Place a record into the table aspc_virtualdb with the layer ID, what this layer extends and other connection details from point 3.

aspc_server gives other information:

i. the database type ( we have used postgres);

ii. what it is called;

iii. what it extends; and where it is physically located.

This, then, is all the information needed for creating the new virtual database.

The new virtual database, pet_store with its unique identification number, 2097152521, now appears in the list of virtual databases in the table aspc_dns (DIAGRAM 3). Databases can have several aliases, so users can find their database under various names

DIAGRAM 3: Virtual Data base names (and aliases)

| aspc master = # | select * from aspc_dns; |
|---|---|
| databaseid | signature |
| 1 | aspc_engine |
| 2 | aspc_app |
| 2130706433 | supertracker |
| 2130706433 | aspc_design |
| 2 | aspc_base |
| 2097152021 | apt |
| 2097152011 | asp_converters |
| 2097152001 | jasonsdb |
| 2097152411 | self_test |
| 2097152421 | self_test1 |
| 2097152431 | self_test2 |
| 2097152331 | jasonsnewdb |
| 2097152341 | terry_db |
| 2097152441 | jasonsnewdb2 |
| 2097152451 | jasondb1 |
| 2097152491 | jasonsdb6 |
| 2097152501 | alison |
| 2097152521 | pet store |
| 2097152531 | battydb |
| 2097152541 | tina |

Diagram 4 shows this same ID number inserted into aspc_virtualaldb. In this way, the new virtual database's relationship in the global system (that is, what layer it extends) is recorded. The pet_store layer extends layer 2, the aspc_app layer.

The new database is where ‘physically’ all the costumer's data is stored. This layer will ‘inherit’ all data from the layers it over-loads. In this case, pet_store will have access to all data from the application layer (aspc_app), and the engine layer (aspc_engine). Data includes classes, fields, people, files, icons, screens, country codes, status codes, and tables etc.

The number gives the location and which database it extends (i.e., it's parent ID). The pet_store DB ID is 2097152521 (in some places this number is expressed as a hexadecimal and will read as 7d000209).

DIAGRAM 4: ASPC Virtual DB table

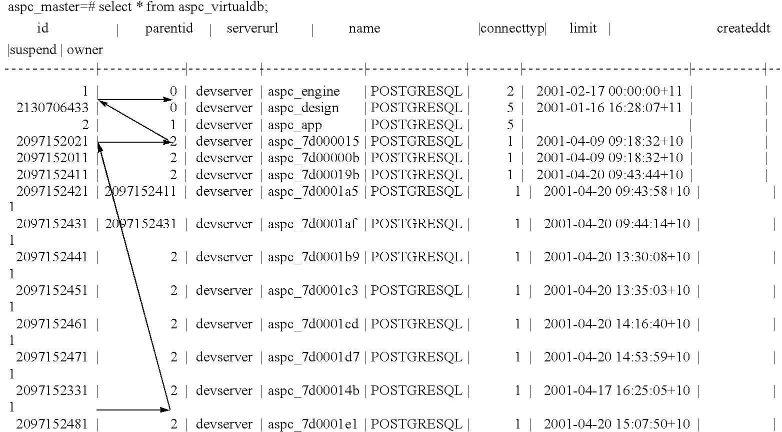

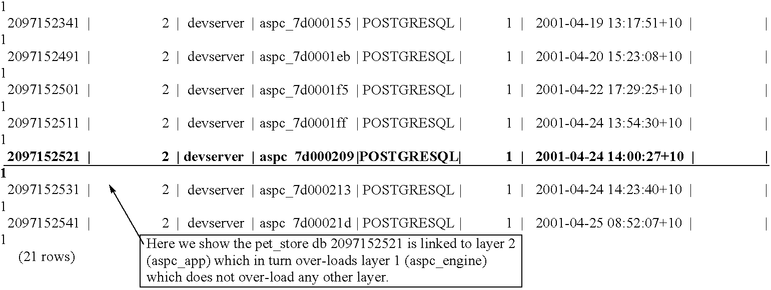

### Physical Tables in the New Pet_store Database

The tables shown in DIAGRAM 5 are all those created for the pet_store virtual database (layer). The table names are made up of a global identifier for the name ( the layer ID), the class ID in that layer of the root class ID (see Diagram 5 [symbol] ).

At the conceptual level of the system, only three tables would be needed. However, this would make searching very slow. So to speed up performance these tables are split up based on the root class. For example, one set for contacts, one for screens, one for payments, and so on. This means to do a search for, say, contacts, only one set of smaller tables has to be scanned.

Each field has a type e.g. float, string, and date. When a record is written to the database, for each field that is marked as ‘searchable’, the data also gets written into the corresponding key table.

DIAGRAM 5: List of relations pet_store virtual database

| Name | Type | Owner | |
|---|---|---|---|
| field_00000001_00000001 | table | servlet_user | |
| field_00000001_00000002 | table | servlet_user | |
| field_00000001_0000000c field_00000001_000000aa field_00000001_000001e0 | table table table | servlet_user servlet_user servlet_user | 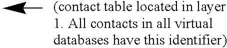 |
| field_00000001_00000262 | table | servlet_user | |
| field_00000001_00000278 | table | servlet_user | |
| field_7d000209_00000002 key_date_00000001_00000001 key_date_00000001_00000002 key_date_00000001_0000000c key_date_00000001_000000aa key_date_00000001_ | | | |
| #000001e0 | table table table table table table | servlet_user servlet_user servlet_user servlet_user servlet_user servlet_user | 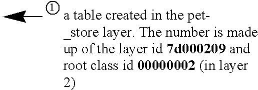 |
| key_date_00000001_00000262 | table | servlet_user | |
| key_date_00000001_00000278 | table | servlet_user | |
| key_date_7d000209_00000002 | table | servlet_user | |
| key_global_00000001_00000001 | table | servlet_user | |
| key_global_00000001_00000002 | table | servlet_user | |
| key_global_00000001_0000000c | table | servlet_user | |
| key_global_00000001_000000aa | table | servlet_user | |
| key_global_00000001_000001e0 | table | servlet_user | |
| key_global_00000001_00000262 | table | servlet_user | |
| key_global_00000001_00000278 | table | servlet_user | |
| key_global_7d000209_00000002 | table | servlet_user | (pet_store global identifier) |
| key_long_00000001_00000001 | table | servlet_user | |
| key_long_00000001_00000002 | table | servlet_user | |
| key_long_00000001_0000000c | table | servlet_user | |
| key_long_00000001_000000aa | table | servlet_user | |
| key_long_00000001_000001e0 | table | servlet_user | |
| key_long_00000001_00000262 | table | servlet_user | |
| key_long_00000001_00000278 | table | servlet_user | |
| key_long_7d000209_00000002 | table | servlet_user | |
| key_string_00000001_00000001 | table | servlet_user | |
| key_string_00000001_00000002 | table | servlet_user | |
| key_string_00000001_0000000c | table | servlet_user | |
| key_string_00000001_000000aa | table | servlet_user | |
| key_string_00000001_000001e0 | table | servlet_user | |
| key_string_00000001_00000262 | table | servlet_user | |
| key_string_00000001_00000278 | table | servlet_user | |
| key_string_7d000209_00000002 | table | servlet_user | (pet_store searchable fields) |
| next_number | table | servlet_user | |
| row_00000001_00000001 | table | servlet_user | |
| row_00000001_00000002 | table | servlet_user | |
| row_00000001_0000000c | table | servlet_user | |
| row_00000001_000000aa | table | servlet_user | |
| row_00000001_000001e0 | table | servlet_user | |
| row_00000001_00000262 | table | servlet_user | |
| row_00000001_00000278 | table | servlet_user | |
| row_7d000209_00000002 | table | servlet_user | (pet_store class) |
| trans_data_00000001_00000001 | table | servlet_user | |
| trans_data_00000001_00000002 | table | servlet_user | |
| trans_data_00000001_0000000c | table | servlet_user | |
| trans_data_00000001_000000aa | table | servlet_user | |
| trans_data_00000001_000001e0 | table | servlet_user | |
| trans_data_00000001_00000262 | table | servlet_user | |
| trans_data_00000001_00000278 | table | servlet_user | |
| trans_data_7d000209_00000002 | table | servlet_user | (pet_store transactions) |
| trans_header | table | servlet_user | |
| trans_record | table | servlet_user | |

20. 2. Create Additional Class in the New Layer

As well as the inherited classes from layers it extends (1 and 2), pet_store requires at least one additional class to store details needed by this type of business (e.g. ‘pet’ id, name, owner and type). The class will not be seen by any other database (unless a decision is made that it might be useful for other types of businesses). If this were the case, the programmer would create a new class in the appropriate layer. If it went into aspc_engine or aspc_app it would be available to all other databases (and users). If it were created in the industry layer (at present there is no industry layer for pet stores) it would be available to all databases that extend that layer.

DIAGRAM 6 Pet class row table
select * from row_00000001_00000001;

| | | | owner_{—} | deleted_{—} |
|---|---|---|---|---|
| row_uid | database_id | class_gid | id | dt |
| 9007201492418953221 | 2097152521 | 1Δ1 | 1 | |
| (1 row) | | | | |

To create any new record requires a row number, the db number, the class (1@1=class 1 in layer 1), the owner, and deleted date. To make one record for anything, one entry in row table giving the row number, then the non-blank fields that it has, for each row are entered in the field table.

One new class, ‘pet’ has been created in the pet_store layer. Pet is now a record of type DB class. Joining row (Diagram 6) and field (Diagram 7) & Global keys (Diagram 8) gives the record details.

The new class called ‘pet’ has been created. It has two fields, a number (2) and name (pet). These values are inserted in 2 rows. Diagram 7 shows how field data is stored—all the system needs is the row id (9007201492418953221) and field id (2381@1). Note that the field id shows what layer it is located in (layer I, aspc_engine). It gives only two values for the class, its id is 2 and that its name is pet.

DIAGRAM 7: Fields for class pet

select * from field_00000001_00000001;

| row_uid | field_gid | value | seq |
|---|---|---|---|
| 9007201492418953221 | 2381@1 | 2 | 0 |
| 9007201492418953221 | 2383@1 | Pet | 0 |
| (2 rows) | | | |

For these fields in this class ‘pet’ there is no row for global keys (Diagram 8) because at the moment these fields are not linked to anything, they have no ‘second dimension’. Later, when we link Pet's owner to person, global key will show the fields second dimension.

DIAGRAM 8: Global keys for class pet

select * from key_global_00000001_00000001;

| row_uid | field_gid | value |
|---|---|---|
| (0 rows) | | |

The transaction data for class pet shows that the row has changed (the sequential number), what field was changed (2381@1). It doesn't say who changed it or what they changed it to or for what class. That is entered later, in transheader and transrecord. These are used for the journaling feature. (NOTE: This is a key feature of the dbase and is very valuable)

DIAGRAM 9: Transaction data for class pet

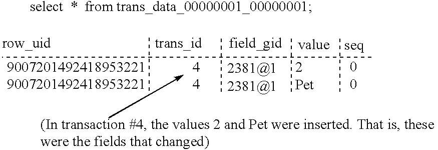

21. 3. Create Additional Fields for Class ‘Pet’: ID, Name, Owner and Type

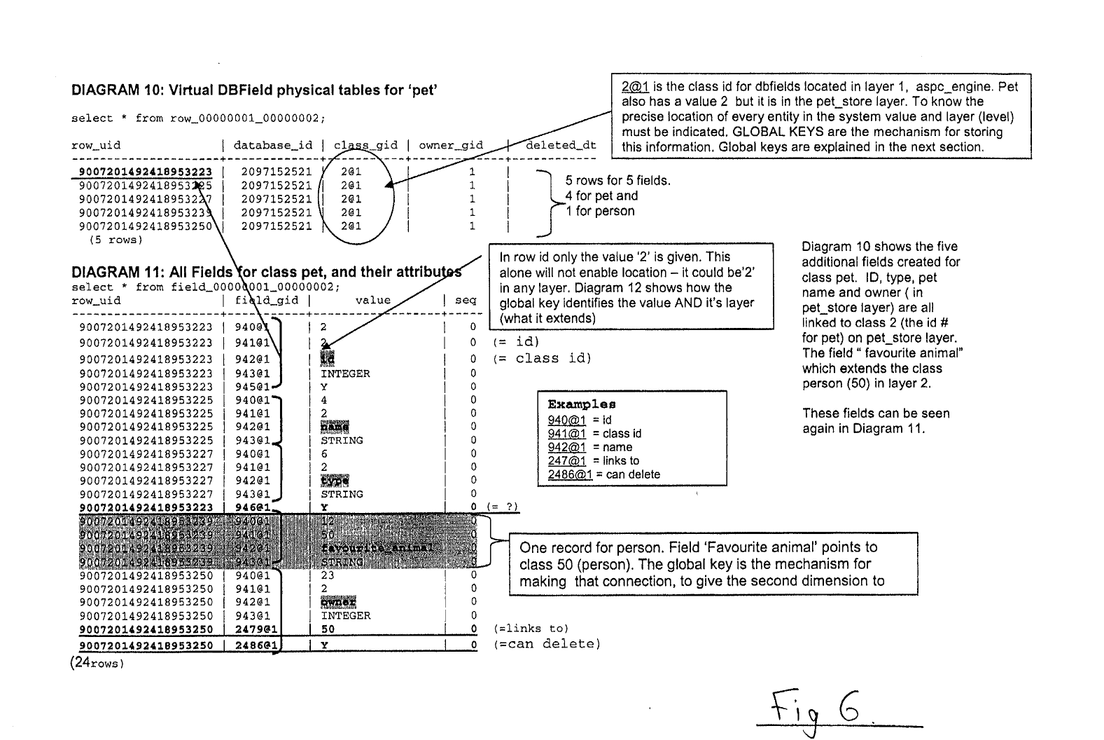

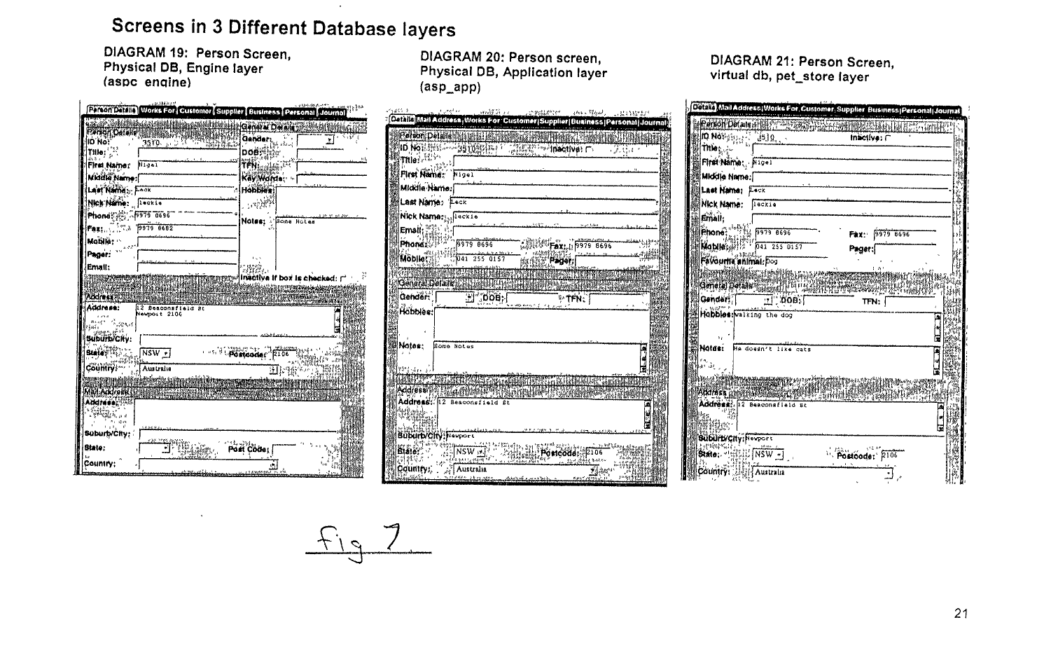

Four fields were then created for the class ‘pet’—id, name, type and owner (as shown in Diagram 10 of FIG. 6). One additional field, ‘favorite animal’ was then created (as shown in Diagram 11) in ‘person’ table (i.e. the existing person class in layer 1 was extended with this additional field). It was created in the pet_store layer and only linked to the layer 1 class because knowing a client or employees ‘favorite animal’ would be relevant to very few business. The field will not be seen by other databases. It is only available in the pet_store layer. If the field had been created in layer 1, all layers above would have been able to see it.

The recursive nature of the system becomes apparent as we go further into creating fields for the new class pet. The class pet has id=2 and has several fields linked to it. One of those fields is the one that says what points to what data.

NOTE:

Classes and fields are just data—no more special than anything else.

All classes are made up of the class itself and the fields that are in that class

In the physical tables for dbclass there is an entry for dbclass and dbfield

Pet is a record of class dbclass

Fido is a record of class pet

Although conceptualizing and articulating this recursiveness is difficult, it is the key to the effectiveness of the system. Because everything is stored and works in the same consistent manner fields can be over-loaded. And the capacity to over-load, extend anything—whether it is a field, a class, value—is what allows us to have a system behaving differently for many different users.

The field ‘owner’ was linked to ‘person’ (class 50) as shown in Diagram But that isn't enough. We need to know the second dimension. The global key shows us that it is 50@ We extended ‘person’ with a new field called ‘favorite animal’ which as was just a piece of text in common class ‘50’—but 50@1—which gives the class that this field is associated with.

### Global Keys (Linkages)

The system must know the location of every entity globally—which layer it is located in. Global keys are the mechanism used for making these linkages—that is, for locating linked fields.

Each field written into the DB is recorded as row id, field id and its value. This is enough information for an unlinked field (that is, one like pet name, created in pet_store layer). If it is a linked field a second dimension must be given to identify which layer it extends (that is, which layer the ‘parent’ field is located in. All linked fields have two dimensions:

1. A Value e.g. NSW, Jim, twenty three

2. What does it link to e.g. person, invoice, address

The Global id is a unique identifier for the value e.g. field_gid=10@1

| row_id | field_gid | value |
|---|---|---|
| 4294969973 | 10@1 | x |

The global key (really just two global ids) gives the value and the class, that is, what it points to. Any record in any database can be found using this identifier.

### Example

### A Field ‘Country’ in Class ‘Person’

The key information for locating the record is the field_gid

| value | @ | database | ˜ | class | @ | database |
|---|---|---|---|---|---|---|
| 1 | @ | 25 (db | ˜ | 50 | @ | 1 |
| | | number) | (separator) | (person) | | (engine) |

DIAGRAM 12: Global Keys in the pet_store example
select * from key_global_00000001_00000002;

| row_uid | field_gid | value |
|---|---|---|
| 9007201492418953225 9007201492418953225 9007201492418953227 9007201492418953227 9007201492418953223 9007201492418953223 9007201492418953239 9007201492418953239 9007201492418953250 9007201492418953250 9007201492418953250 | 941@1 943@1 941@1 943@1 941@1 943@1 941@1 943@1 247@1 941@1 943@1 | 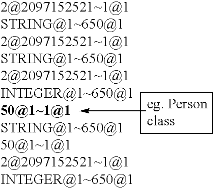 |
| (11 rows) | | |

The new class pet has been created with four new fields. One new field has been created in person class(favorite animal). The field ‘owner’ in Pet is a linked field which points to person class in layer 1, aspc_engine. Only the ‘owner’ field requires a Global key to indicate the location of the linked class.

22. 4. Extend the Class ‘Person’ with a New Field Called ‘Favorite Animal’

Extend is the term used to describe adding additional fields to the class person. For example, the class person (in contact, layer 1) was ‘extended’ in the pet_store layer to include a new field ‘owner’. Although the extended class is in layer 1, this layer is not affected and no other users will see the newly created class ‘owner’. In the example shown (Diagram 14) Nigel Leck has been entered in the engine layer. This is for demonstration purposes only and would not usually be done, as this entry will now appear in all layers above.

23. 5. Create a New Record for Person, Tina Leck

Details about pet owners are stored in ‘person’ Although a field, ‘owner’, has been created for the pet_store layer, as explained previously, it is a linked field which points to class ‘person’ which is located in layer 1. Diagrams 30 shows the physical tables for ‘contact’. The new record for person Tina Leck is inserted and registers in the pet_store layer along with the over-loaded record.

DIAGRAM 13: Row table for ‘Contact’

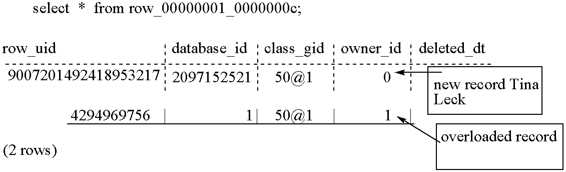

24. 6. Create Two Records for Pet

The five fields created for pet_store can now be viewed appear on the screen of the user's virtual object oriented database. Two new records are created for pet details, as shown in Diagrams 18 and 19. The data entry screen for these records are shown in Diagrams 14 and 15.

[image]

When storing a record only the differences to the record at the layer below are stored.

8.Modify a pre-existing Record for person by Over-loading

In this section of the example a record for Nigel Leck (as explained previously, normally only items required by all users (perhaps countries) would be entered in the engine layer. Here it was done for demonstration purposes—to show how it was over-loaded in the application and pet_store layers.

### Over-loading a Field

Over-loading is the term used to describe any change made to a record from layers below. For example, the phone and notes fields in pet_store were over-loaded with new data in field that exist in layers below it.

DIAGRAM 18: fields for contact in pet_store layer

select * from field_00000001_0000000c;

| row_uid | | field_gid | value | seq |
|---|---|---|---|---|
| 9007201492418953217 | | 40@1 | Nigel Leck | 0 |
| 9007201492418953217 | | 55@1 | 9999 | 0 |
| 9007201492418953217 | | 10@1 | 1 | 0 |
| 9007201492418953217 | | 62@1 | Nigel | 0 |
| 9007201492418953217 | | 64@1 | Leck | 0 |
| | 4294969756 | 1931@1 | walking the | 0 (hobby) |
| | | | dog | |
| 9007201492418953217 | | 12@2097152521 | himself | 0 |
| | 4294969756 | 57@1 | He doesn't | 0 |
| | | | like cats | |
| | 4294969756 | 12@2097152521 | Dog | 0 |

(9 rows)

Field 1931@1 already exists in class contact in layer 1 (as shown in Diagram 13) and has been over-loaded in the pet_store layer to become the field ‘hobby’.

The diagrams 19, 20 and 21 of FIG. 7 show screens for the same contact person record in three different layers,

1. layer 1, engine (aspc_engine)—the default screen

2. layer 2, application layer, aspc_app—the default screen with altered layout

3. the new virtual database, pet_store—the default screen with altered layout and added field

This demonstrates that in the pet_store layer only three field need to be overloaded, hobby, notes (both over-loaded) and the new field “favorite animal” (value=dog).

i. In engine there is no entry for mobile phone (Diagram 19), it is listed in the application level (Diagram 17) and is then inherited into the pet_store layer.

ii. The fax number from engine is over-loaded (with a changed number) in the application level. This is the number that is then inherited into the pet_store layer.

iii. Notes are the same in engine and application level, but over-loaded in the pet_store layer (with the value “he doesn't like cats”).

iv. Hobbies has no entry in engine or application but is over-loaded in pet_store with an entry “walking the dog” (Diagram 21).

v. A new field ‘favorite animal’ has been added to the pet_store layer and the value ‘dog’ entered (Diagram 21)

Physical tables for ‘Contact’ aspc_engine layer
DIAGRAM 22: Row table for ‘Contacts’ (sample only)
select * from row_00000001_0000000c where row_uid = 4294969756;

| row_uid | database_id | row_id | class_gid | owner_id | deleted_dt |
|---|---|---|---|---|---|
| 4294969756 | 1 | 2460 | 50@1 | 3510 | |

(1 row)

DIAGRAM 23: Field table for ‘Contacts’
select * from field_00000001_0000000c where row_uid = 4294969756;

| row_uid | field_gid | value | seq |
|---|---|---|---|
| 4294969756 | 10@1 | 3510 | 0 |
| 4294969756 | 40@1 | Nigel Leck | 0 |
| 4294969756 | 51@1 | AU | 0 |
| 4294969756 | 52@1 | NSW | 0 |
| 4294969756 | 53@1 | 12 Beaconsfield St Newport 2106 | 0 |
| 4294969756 | 54@1 | 2106 | 0 |
| 4294969756 | 55@1 | 9979 8696 | 0 |
| 4294969756 | 57@1 | Some Notes | 0 |
| 4294969756 | 62@1 | Nigel | 0 |
| 4294969756 | 64@1 | Leck | 0 |
| 4294969756 | 65@1 | nigel@lecklogic.com.au | 0 |
| 4294969756 | 56@1 | 9979 8682 | 0 |
| 4294969756 | 70@1 | leckie | 0 |
| (13 rows) | | | |

### Physical tables for ‘Contact’ aspc_app Layer

DIAGRAM 24: Row table for ‘Contact’ aspc_app layer
select * from row_00000001_0000000c where row_uid = 4294969756;

| row_uid | database_id | row_id | class_gid | owner_id | deleted_dt |
|---|---|---|---|---|---|
| 4294969756 | 1 | 1 | 50@1 | 3510 | |

(1 row)

DIAGRAM 25: Field table for ‘Contact’ aspc_app layer
select * from field_00000001_0000000c
where row_uid = 4294969756;

| row_uid | field_gid | value | seq |
|---|---|---|---|
| 4294969756 | 71@1 | 041 255 0157 | 0 |
| 4294969756 | 56@1 | 9979 8680 | 0 |
| (2 rows) | | | |

DIAGRAM 26: Global keys table for ‘Contact’ aspc_app layer
select * from key_global_00000001_0000000c
where row_uid = 4294969756;

| row_uid | field_gid | value |
|---|---|---|
| (0 rows) | | |

DIAGRAM 27: Transaction Data table for ‘Contact’ aspc_app layer
select * from trans_data_00000001_0000000c
where row_uid = 4294969756;

| row_uid | trans_id | field_gid | value | seq |
|---|---|---|---|---|
| 4294969756 | 32522 | 71@1 | | 0 |
| 4294969756 | 32522 | 79@1 | | 0 |
| 4294969756 | 32522 | 56@1 | | 0 |

(3 rows)

### Physical tables for ‘Contact’ pet_store layer

The same pattern of table exists for pet-store layer, row, field and global ID. This consistency in structure is the key to the system's power. Everything within every dbase is stored in the same way.

[image]

Fields which have been over-loaded (they exist in another layer) can be identified by their different row with id. Their number is shorter as it only shows the record number (4294969756) and does not include the dbase id (in this case, 9007201). Here the new record Tina Leck and other pet_store fields can be identified by the pet_store db id 9007201.

DIAGRAM 30: Global keys table for ‘Contact’
select * from key_global_00000001_0000000c;

| | | |
|---|---|---|
| row_uid | field_gid | value |

(0 row)

25. 9. Storing and Inquiry: Notes and Example (Not Pet Store Specific) Storing (Physical Level)

To save data only two things must occur.

1. each record is put into a row table by its row number

2. each field is put into a field table (row id, field, value)

The row id (a 64 bit number containing the layer id and the unique row id) gives the location (what layer/database) it is owned by. Once this is known the system is directed to each layer from the base up, loading into each to build to the aggregate of the all the fields. As it proceeds with this operation, new data replaces what was located in the previous layer.

As with other functions, additional performance enhancements have been added, for example, rather than storing in a single huge table, separate tables have been created to increase speed.

### Making an Inquiry (Illustration of the Separation of Databases)

The inquiry process is the same no matter what is being requested, a person, a class a field etc.

### Example

How to Find all Contacts in a Company Database Contact=12@1

_company (52@1)

_person (50@1)

_favorite restaurant (30@70)

Here, Layer 70 (the company database) extends layer 2 (application) which extends 1 (the engine). Commands would be:

_Search company layer (70)

Each inquiry executes three physical queries:

| | |
|---|---|
| Layer 70 | select row_uid/xlayer companyx/ from field |
| (company layer) | 000000010000000c where class_gid is |
| | (‘12@1’, ‘52@1’. ‘50@1’, ‘30@70’) |
| Layer 2 | select row_uid / x layer:appx / from field |
| (application) | 00000001_0000000c where class_gid is |
| | (‘12@1’, ‘50@1’) |
| Layer 1 | “ ” select |
| (engine) | |

### For a Specific Inquiry

(Remembering that all fields can be over-loaded. This adds a level of complexity to the search process.

A series of six inquiries must be made

### Example

Find all People in NSW with a Mobile Phone

Two strategies, depending on where item is located:

1. In the current layer

_Request all records that match this (value), and this (value). The process of firing off three inquiries would occur i.e. all fields matching the search criteria in this layer. (an AND condition)

2. Then because all fields can be over-loaded, a second inquiry needs to be done to check the two layers which may have been extended. Layer (1) cannot be extended and therefore does not need checking.

This search would be “Search for all records not owned by this layer that any of these fields match (an OR condition)

### Example

In layer 1 (aspc_engine)

Inquiry task: To retrieve one object (e.g. customer last name) of class person

Class: PERSON (50)

Field: id (10 Field: phone (55)

Field: name (40) Field: gender (79)

_The system would request all rows of class 50 (person)

_Results in a list of all row numbers for all people listed in the database

_Select row field

_Select row ID number

_data for row (objects)

At the virtual level, once the row ID is located data is loaded to the object.

26. 8. TERMINOLOGY

| | Descriptor | |
|---|---|---|
| | or | |
| | abbreviation | |
| Item/Term | used | Explanation |
| Attribute | | property of a relation |
| business rule | | a restriction on an organization's activities that |
| | | must be reflected in any model of that organization |
| Class | | logical group represented by a table e.g. contact, |
| | | task |
| Client | | that part of a DBMS that displays information on a |
| | | screen and responds to user input (i.e. the front |
| | | end) |
| Column | | a component of a table that holds a single |
| | | attribute of the table |
| Conceptual | CL | all the elements needed for the system to function |
| level | | |
| Database | | self-describing (i.e. data includes a description |
| | | of its own structure) collection of integrated |
| | | records |
| Database | DB | user interface programs that work with a database |
| application | | to maintain and deliver information (including |
| | | screens, reports, inquiries) |
| database engine | engine | that part of a DBMS that directly interacts with |
| | | the database |
| Database | DBMS | stores all the information about the physical |
| management | | location of data stored in a database |
| system | | |
| database server | DBServer | computer or group of computers where the physical |
| | | database is held |
| Extend | | create an entity by using information in tables in |
| | | layers below current layer |
| Implementation | IL | conceptual level elements plus additional |
| level | | elements created for performance or |
| | | commercial reasons e.g. id of account holder |
| Inherit | | entities in any layer which have been created in a |
| | | layer or layers below. For example the person |
| | | contact is stored in the engine layer but is |
| | | inherited by all layers above it. |
| Key | | unique value which acts as a row identifier in a relation |
| Layer | layer | database located above the master database |
| Overload | | make any change in a record located in a layer |
| | | below. The resulting change is seen only in |
| | | the over-loaded layer. |
| Mask | | system number out of an allocated range |
| Parent | | the single entity in a one-to-many |
| | | relationship (in this system, that which is |
| | | extended) |
| Relation | | two dimensional array of rows and columns |
| | | (table) containing single-value entries and no |
| | | duplicate rows |
| Row | | individual instance of a relation |
| Table | | a relation expressed as a two dimensional |
| | | array of rows and columns |
| Transaction | | a sequence of SQL statements whose effect is |
| | | not accessible to other transactions until all |
| | | the statements are executed. |
| Virtual | VH | Functioning through connection with |
| | | attribute(s) of a physical entity, but having |
| | | no actual embodiment itself. |
| Virtual | VDB | as seen by the user, a combination of layers |
| database | | through from the engine upwards |

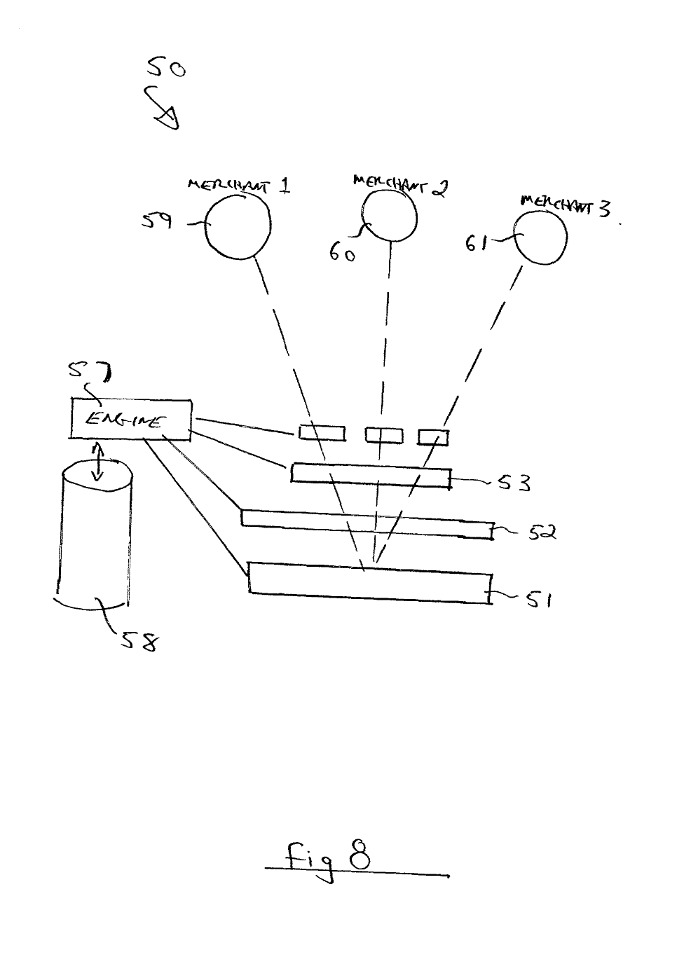

With reference to FIG. 8 there is illustrated an implementation of the previously described system as what may be termed a “bureau model”. The database management system of FIG. 8 s a single hosted system comprised of hierarchically arranged database layers, each database being independent of any other. In this instance there is a host database layer 51 hierarchically above which lies a general applications database layer 52 above which is an industry specific database 53 and above which again are, in this instance, three separate industry member databases 54, 55, 56.

Each of these separate databases 51, 52, 53, 54, 55, 56 has the communications between adjacent layers managed by engine 57 in conjunction with master database 58.

Each database comprises rows and fields as previously described and defined in a recursive manner.

In this example the host layer 51 is a database which provides the logical structure definition for the entire integrated database management system 50 including such things as logins, definitions of people and the like. Layer 52 is a database which defines general applications data suited to all industry specific members, in this instance comprising first of merchant 59, second merchant 60 and third merchant 61.

Each merchant 59, 60, 61 “sees”, via its respective industry member specific database 54, 55, 56 only that data pertinent to it, no matter from which of the layers 51, 52, 53 it is derived.

In terms of the maintenance of databases, each individual database can be maintained independently of any other because of the manner in which the data structures within each database are defined and by virtue of the tracking function provided by engine 57 in conjunction with database 58.

Although the invention has been described with reference to specific examples, it will be appreciated by those skilled in the art that the invention may be embodied in many other forms.

What is claimed is:

1. A database for use by a plurality of user groups, the database including: designation means for designating data into one of the following sets:
a general set for data of potential general applicability to all user groups, the data within the general set being customizable only by one or more system administrators; and
a specific set for each individual user group for data of potential applicability to only that user group, the data within the specific set being customizable only by the user group;
whereby the information as presented to any selected user group is the result of aggregation of the data from the general set and the specific set for the selected group.

2. The database of claim 1 wherein the sets into which the designation means is capable of designating data further includes one or more intermediate sets for data of potential applicability to one or more sub-sets of user groups respectively.

3. The database of claim 2 wherein data within the intermediate sets is customizable only by one or more system administrators.

4. The database of claim 1 wherein the data stored in each of the sets is stored in a uniform format.

5. The database of claim 4 wherein the uniform format comprises three tables.

6. The database of claim 5, wherein the three tables comprise a row table, a field table and a global key table.

7. An integrated database system comprised of a plurality of independent databases conceptually arranged in a hierarchy.

8. The system of claim 7 wherein each of the databases is graded to a given level of specificity.

9. The system of claim 8 wherein the system includes a database interpreter which filters data derived from adjacent ones of the layers so as to produce a logical view for a user of the database system.

10. A data structure for a database system, the database system comprising a plurality of independent databases conceptually arranged in a hierarchy, wherein data is defined in rows and fields as a many to one mapping of fields to rows.

11. The data structure of claim 10 wherein the data structure incorporating a common architecture to store classes and fields and to store data and thereby to provide an available audit trail to the field structure and the data.
